(19) United States
(12) Patent Application Publication
(10) Pub. No.: US 2017/0188140 A1
(43) Pub. Date: Jun. 29, 2017

(54) Controlling audio beam forming with video stream data

(71) Applicant: Intel Corporation, Santa Clara, CA (US)

(72) Inventors: Karol J. Duzinkiewicz, Banino (PL); Lukasz Kurylo, Gdansk (PL); Michal Borwanski, Gdynia (PL)

(73) Assignee: Intel Corporation, Santa Clara, CA (US)

(21) Appl. No.: 14/757,885

(22) Filed: Dec. 24, 2015

(51) Int. Cl. H04R 3/00; H04R 1/40

(52) U.S. Cl. CPC H04R 3/005; H04R 1/406; H04R 2499/11; H04R 2430/23; H04R 2410/01

(57) ABSTRACT

Audio beam forming control is described herein. A system may include a camera, a plurality of microphones, a memory, and a processor. The memory is to store instructions and that is communicatively coupled to the camera and the plurality of microphones. The processor is communicatively coupled to the camera, the plurality of microphones, and the memory. When the processor is to execute the instructions, the processor is to capture a video stream from the camera, determine, from the video stream, an audio source position, capture audio from the primary audio source position at a first direction, and attenuate audio originating from other than the first direction.

### TECHNICAL FIELD

The present techniques relate generally to audio processing systems. More specifically, the present techniques relate to controlling audio beam forming with video stream data.

### BACKGROUND ART

Beam forming is a signal processing technique that can be used for directional signal transmission and reception. As applied to audio signals, beam forming can enable the directional reception of audio signals. Often, audio beam forming techniques will capture the sound from the direction of the loudest detected sound source.

### BRIEF DESCRIPTION OF THE DRAWINGS

FIG. 1 is a block diagram of an electronic device that enables audio beam forming to be controlled with video stream data;

FIG. 2A is an illustration of a system that includes a laptop with audio beam forming controlled by video stream data;

FIG. 2B is an illustration of a system that includes a laptop with audio beam forming controlled by video stream data;

FIG. 3 is an illustration of a face rectangle within a camera field of view;

FIG. 4 is an illustration of a user at an electronic device;

FIG. 5 is an illustration of a system that includes a laptop with audio beam forming controlled by video stream data;

FIG. 6 is a process flow diagram of an example method for beam forming control via a video data stream; and

FIG. 7 is a block diagram showing a tangible, machine-readable media that stores code for beam forming control via a video data stream.

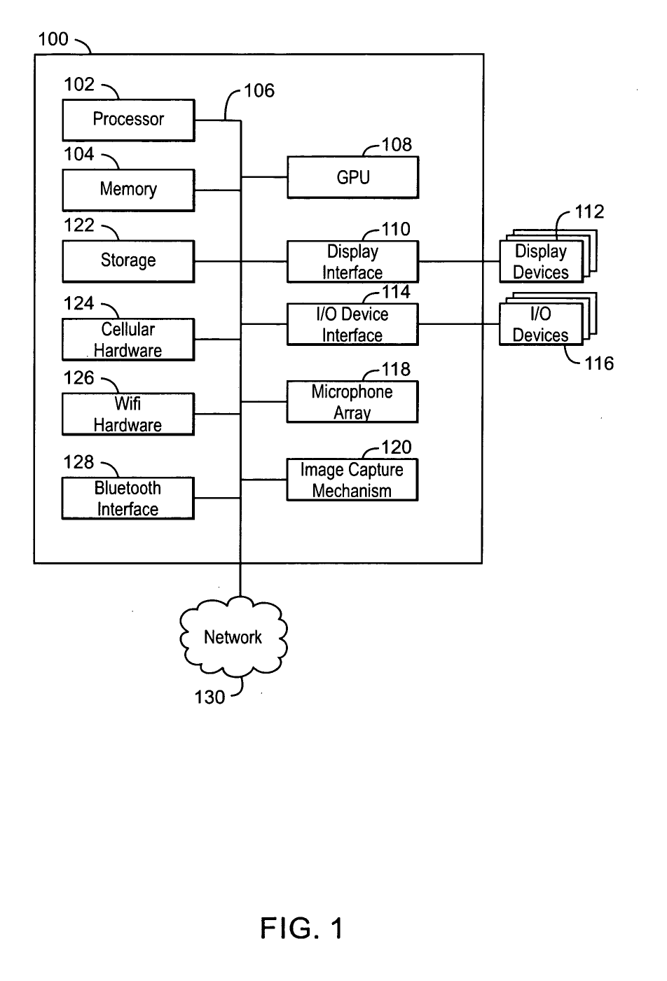

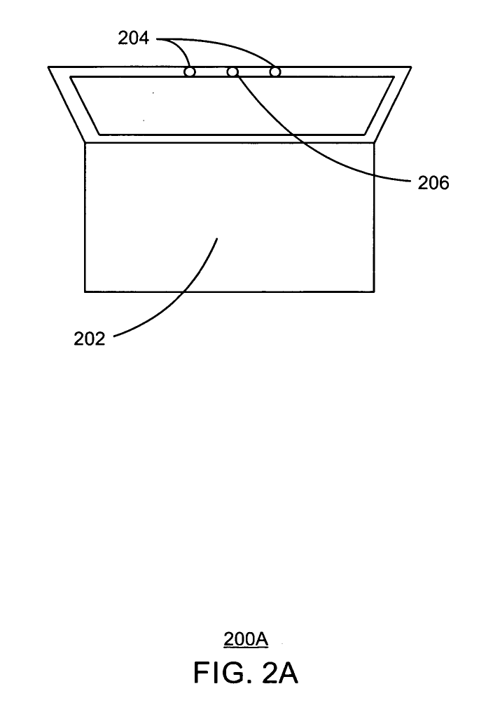

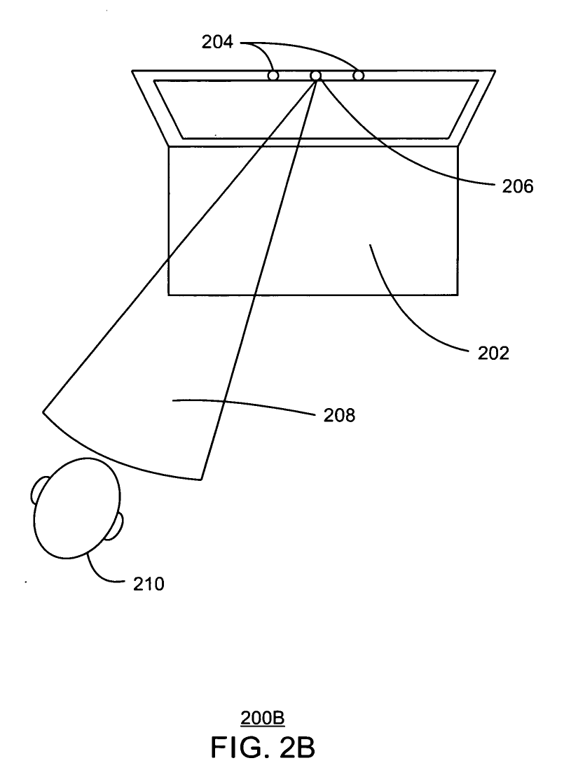

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As discussed above, audio beam forming techniques frequently capture the sound from the direction of the loudest detected sound source. Loud noises, such as speech or music from speakers in the same general area as the beam former, can be detected as sound sources when louder than an actual speaker. In some current applications, a beam forming algorithm can switch the beam direction in the middle of speech to the loudest sound source. This results in a negative impact on the overall user experience.

Embodiments disclosed herein enable audio beam forming to be controlled with video stream data. The video stream may be captured from a camera. An audio source position may be determined from the video stream. Audio can be captured from the audio source position, and audio originating from positions other than the audio source are attenuated. In embodiments, using detected speaker's position to control the audio beam position makes the beam forming algorithm insensitive to loud side noises.

Some embodiments may be implemented in one or a combination of hardware, firmware, and software. Further, some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an electronic device that enables audio beam forming to be controlled with video stream data. The electronic device 100 may be, for example, a laptop computer, tablet computer, mobile phone, smart phone, or a wearable device, among others. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102. The memory device 104 can include random access memory (RAM), read only memory (ROM), flash memory, or any other suitable memory systems. For example, the memory device 104 may include dynamic random access memory (DRAM).

The electronic device 100 also includes a graphics processing unit (GPU) 108. As shown, the CPU 102 can be coupled through the bus 106 to the GPU 108. The GPU 108 can be configured to perform any number of graphics operations within the electronic device 100. For example, the GPU 108 can be configured to render or manipulate graphics images, graphics frames, videos, or the like, to be displayed to a user of the electronic device 100. In some embodiments, the GPU 108 includes a number of graphics engines, wherein each graphics engine is configured to perform specific graphics tasks, or to execute specific types of workloads. For example, the GPU 108 may include an engine that processes video data. The video data may be used to control audio beam forming.

While particular processing units are described, the electronic device 100 may include any number of specialized processing units. For example, the electronic device may include a digital signal processor (DSP). The DSP may be similar to the CPU 102 described above. In embodiments, the DSP is to filter and/or compress continuous real-world analog signals. For example, an audio signal may be input to the DSP, and processed according to a beam forming algorithm as described herein. The beam forming algorithm herein may consider audio source information when identifying an audio source.

The CPU 102 can be linked through the bus 106 to a display interface 110 configured to connect the electronic device 100 to a display device 112. The display device 112 can include a display screen that is a built-in component of the electronic device 100. The display device 112 can also include a computer monitor, television, or projector, among others, that is externally connected to the electronic device 100. The CPU 102 can also be connected through the bus 106 to an input/output (I/O) device interface 114 configured to connect the electronic device 100 to one or more I/O devices 116. The I/O devices 116 can include, for example, a keyboard and a pointing device, wherein the pointing device can include a touchpad or a touchscreen, among others. The I/O devices 116 can be built-in components of the electronic device 100, or can be devices that are externally connected to the electronic device 100.

The electronic device 100 also includes a microphone array 118 for capturing audio. The microphone array 118 can include any number of microphones, including two, three, four, five microphones or more. In some embodiments, the microphone array 118 can be used together with an image capture mechanism 120 to capture synchronized audio/video data, which may be stored to a storage device 122 as audio/video files. In embodiments, the image capture mechanism 112 is a camera, stereoscopic camera, image sensor, or the like. For example, the image capture mechanism may include, but is not limited to, a camera used for electronic motion picture acquisition.

Beam forming may be used to focus on retrieving data from a particular audio source, such as a person speaking. To control the direction of beam forming, the reception directionality of the microphone array 118 may be controlled by a video stream received by the image capture mechanism 118. The reception directionality is controlled in such a way as to amplify certain components of the audio signal based on the relative position of the corresponding sound source relative to the microphone array. For example, the directionality of the microphone array 118 can be adjusted by shifting the phase of the received audio signals and then adding the audio signals together. Processing the audio signals in this manner creates a directional audio pattern such that sounds received from some angles are more amplified compared to sounds received from other angles. In embodiments, signals may be amplified via constructive interference, and attenuated via deconstructive interference.

Additionally, in some examples, beam forming is used to capture audio data from the direction of a targeted speaker. The speaker may be targeted based on video data captured by the image capture mechanism 120. Noise cancellation may be performed based on the data captured by the data obtained by the sensors 114. The data may include, but is not limited to, a face identifier, face rectangle, vertical position, horizontal position, and distance. In this manner, robust audio beam direction control may be implemented via an audio beam forming algorithm used in speech audio applications running on devices equipped with microphone arrays.

The storage device 122 is a physical memory such as a hard drive, an optical drive, a flash drive, an array of drives, or any combinations thereof. The storage device 122 can store user data, such as audio files, video files, audio/video files, and picture files, among others. The storage device 122 can also store programming code such as device drivers, software applications, operating systems, and the like. The programming code stored to the storage device 122 may be executed by the CPU 102, GPU 108, or any other processors that may be included in the electronic device 100.

The CPU 102 may be linked through the bus 106 to cellular hardware 124. The cellular hardware 124 may be any cellular technology, for example, the 4G standard (International Mobile Telecommunications-Advanced (IMT-Advanced) Standard promulgated by the International Telecommunications Union-Radio communication Sector (ITU-R)). In this manner, the PC 100 may access any network 130 without being tethered or paired to another device, where the network 130 is a cellular network.

The CPU 102 may also be linked through the bus 106 to WiFi hardware 126. The WiFi hardware is hardware according to WiFi standards (standards promulgated as Institute of Electrical and Electronics Engineers' (IEEE) 802.11 standards). The WiFi hardware 126 enables the wearable electronic device 100 to connect to the Internet using the Transmission Control Protocol and the Internet Protocol (TCP/IP), where the network 130 is the Internet. Accordingly, the wearable electronic device 100 can enable end-to-end connectivity with the Internet by addressing, routing, transmitting, and receiving data according to the TCP/IP protocol without the use of another device. Additionally, a Bluetooth Interface 128 may be coupled to the CPU 102 through the bus 106. The Bluetooth Interface 128 is an interface according to Bluetooth networks (based on the Bluetooth standard promulgated by the Bluetooth Special Interest Group). The Bluetooth Interface 128 enables the wearable electronic device 100 to be paired with other Bluetooth enabled devices through a personal area network (PAN). Accordingly, the network 130 may be a PAN. Examples of Bluetooth enabled devices include a laptop computer, desktop computer, ultrabook, tablet computer, mobile device, or server, among others.

The block diagram of FIG. 1 is not intended to indicate that the electronic device 100 is to include all of the components shown in FIG. 1. Rather, the computing system 100 can include fewer or additional components not illustrated in FIG. 1 (e.g., sensors, power management integrated circuits, additional network interfaces, etc.). The electronic device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

The present techniques enable robust audio beam direction control for an audio beam forming algorithm used in speech audio applications running on devices equipped with microphone arrays. Moreover, the present techniques are not limited to capturing the sound from the direction of the loudest detected sound source and thus can perform well in noisy environments. Video stream data from a camera can be used to extract the current position of the speaker, e.g. by detecting speaker's face or silhouette. The camera may be a built in image capture mechanism as described above, or the camera may be an external USB camera module with a microphone array. Placing the audio beam in the direction of detected speaker gives much better results when compared to beam forming without position information, especially in noisy environments where the loudest sound source can be something else than the speaker himself.

Video stream data from a user-facing camera can be used to extract the current position of the speaker by detecting speaker's face or silhouette. The audio beam capture is then directed toward the detected speaker to capture audio clearly via beam forming, especially in noisy environments where the loudest sound source can be something else than the speaker whose audio should be captured. Beam forming will enhance the signals that are in phase from the detected speaker, and attenuate the signals that are not in phase from areas other than the detected speaker. In embodiments, the beam forming module may apply beam forming to the primary audio source signals, using their location with respect to microphones of the computing device. Based on the location details calculated when the primary audio source location is resolved, the beam forming may be modified such that the primary audio source does not need to be equidistant from each microphone.

FIG. 2A is an illustration of a system 200A that includes a laptop with audio beam forming controlled by video stream data. The laptop 202 may include a dual microphone array 204 and a built in camera 206. As illustrated, the microphone array includes two microphones located equidistant from a single camera 206 along the top portion of laptop 202. However, any number of microphones and cameras can be used according to the present techniques. A direction from which the beam former processing should capture sound is determined by the direction in which the speaker's face/silhouette is detected by the camera. By providing the speaker's position periodically to the beam former algorithm, the beam former algorithm can dynamically adjust the beam direction is real time. The speaker's position may also be provided as an event or interrupt that is sent to the beam former algorithm when the direction of the user has changed. In embodiments, the change in direction should be greater than or equal to a threshold in order to cause an event or interrupt to be sent to the beam former algorithm.

FIG. 2B is an illustration of a system 200B that includes a laptop with audio beam forming controlled by video stream data. In embodiments, a beam forming algorithm is to process the sound captured by the two microphones 204 and adjust the beam forming processing in such a way that it will capture only sounds coming from a specific direction in space and will attenuate sounds coming from other directions. Accordingly, a user 210 can be detected by the camera 206. The camera is used to determine a location of the user 210, and the dual microphone array will capture sounds from the direction of user 210, which is represented by the audio cone 208. In this manner, the direction from which the beam former should capture sound is determined by the direction in which the speaker's face/silhouette is detected. By providing the speaker's position periodically to the beam former algorithm it can dynamically adjust the beam direction.

In embodiments, the face detection algorithm is activated when a user is located within a predetermined distance of the camera. The user may be detected by, for example a sensor that can determine distance or via the user's manipulation of the computer. In some cases, the camera can periodically scan its field of view to determine if a user is present. Additionally, the face detection algorithm can work continuously on the device analyzing image frames captured from the built-in user-facing camera.

When a user is present within the field of view of the camera, subsequent frames are processed to determine the position of all detected human faces or silhouettes. The frames processed may be each subsequent frame, every other frame, every third frame, every fourth frame, and so on. In embodiments, the subsequent frames are processed in a periodic fashion. Each detected face can be described by the following information: face identification (ID), face rectangle, vertical position, horizontal position, and distance away from the camera. In embodiments, the face ID is a unique identification number assigned to each face/silhouette detected in the camera's field of view. A new face entering the field of view will receive a new ID, and the ID's of speakers already present in the system are not modified.

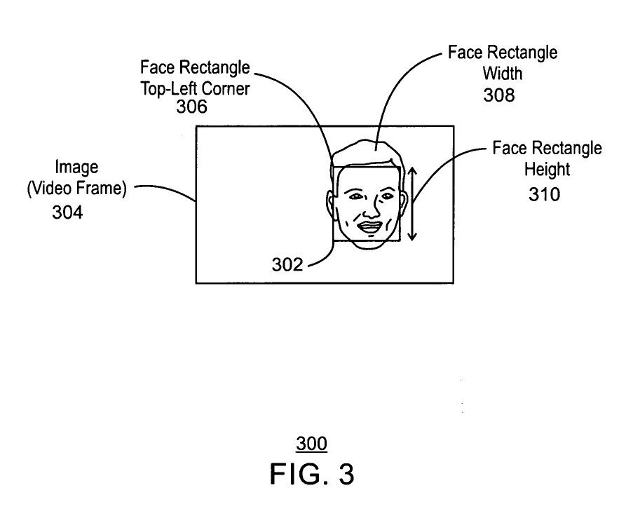

FIG. 3 is an illustration of a face rectangle within a camera field of view 300. A face rectangle 302 is a rectangle that includes person's eyes, lips & nose. In embodiments, the face rectangle's edges are always in parallel with the edges of the image or video frame 304, wherein the image includes the full field of view of the camera. The face rectangle 302 includes a top left corner 306, and has a width 308 and a height 310. In embodiments, the face rectangle is described by four integer values: first, the face rectangle's top left corner horizontal position in pixels in image coordinates; second, the face rectangle's top left corner vertical location in pixels in image coordinates; third, face rectangle's width in pixels; and fourth, the face rectangle's height in pixels.

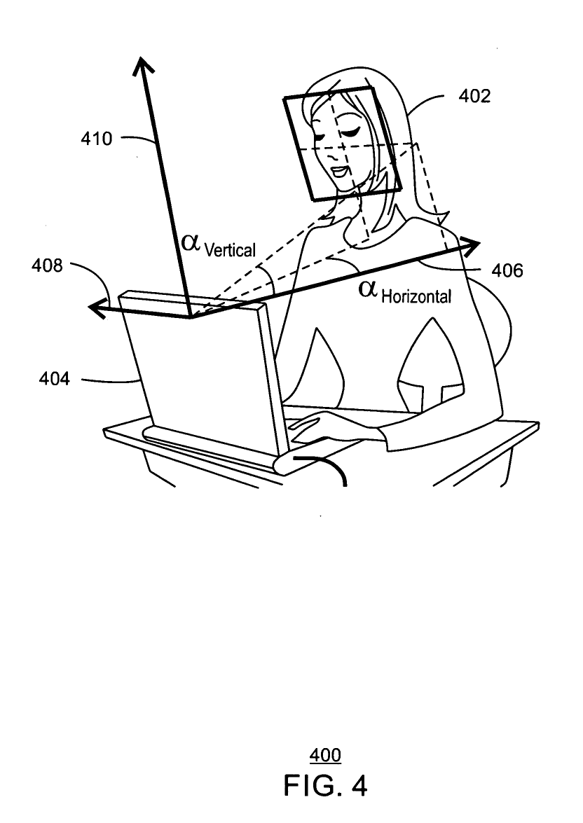

FIG. 4 is an illustration of a user at an electronic device. The user 402 is located within a field of field of the electronic device 404. As illustrated the field of view is centered at the camera of the electronic device, and can be measured along an x-axis 406, a y-axis 408, and a z-axis 410. The vertical position α_{vertical} is a face vertical position angle, that can be calculated, in degrees, by the following equation:

$${α}_{vertical} = \frac{{FOV}_{vertical} - ( \frac{H}{2} - {FC}_{y} )}{H}$$

where FOV_{vertical} is the vertical FOV of the camera image in degrees, H is the camera image's height (in pixels), and FC_{y} is the face rectangle's center position along image Y-axis in pixels.

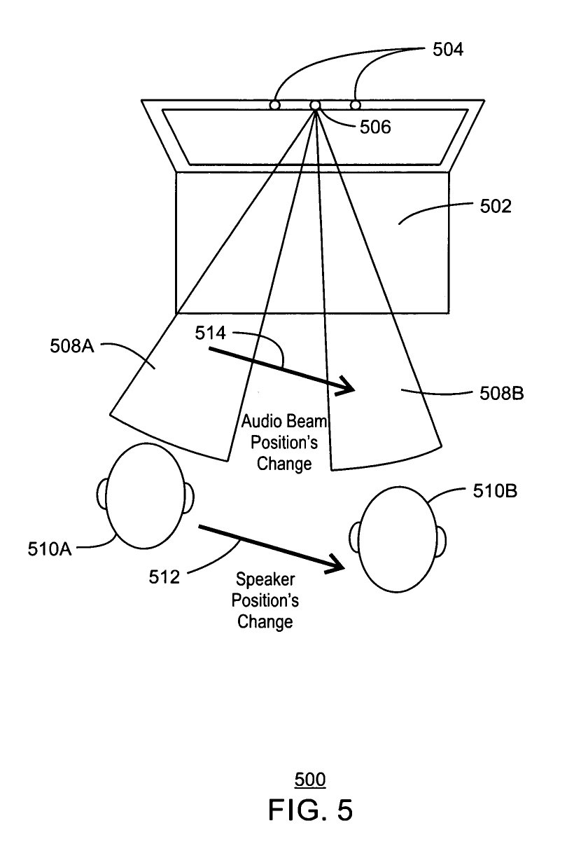

Similarly, The horizontal position α_{horizontal} is a face horizontal position angle, that can be calculated, in degrees, by the following equation:

$${α}_{horizontal} = \frac{{FOV}_{horizontal} - ( \frac{W}{2} - {FC}_{x} )}{W}$$

where FOV_{horizontal} is the horizontal FOV of the camera image in degrees, W is the camera image's width (in pixels), and FCₓ is the face rectangle's center position along the image X-axis in pixels. The equations above assume the image capture occurs without distortion. However, distortion due to the selection of optical components such as lenses, mirrors, prisms and the like, as well as distortion due to image processing is common. If video data captured by the camera is distorted, then the above equations may be adapted to account for those distortions to provide correct angles for the detected face. In some cases, the detected face may also be described by the size of the face relative to the camera field of view. In embodiments, the size of a face within the field of view can be used to estimate a distance of the face from the camera. Once the distance of the face from the camera is determined, angles such as α_{vertical} and α_{horizontal} may be derived. Once the angles have been determined, the position of detected speakers' faces is provided to the beam forming algorithm as s periodic input. The algorithm can then adjust the beam direction when the speaker changes its position during time as illustrated in FIG. 5.

FIG. 5 is an illustration of a system 500 that includes a laptop with audio beam forming controlled by video stream data. Similar to FIGS. 2A and 2B, a beam forming algorithm is to process the sound captured by the two microphones 504 and adjust the beam forming processing in such a way that it will capture only sounds coming from a specific direction in space and will attenuate sounds coming from other directions. Accordingly, a user at circle 510A can be detected by the camera 506. The camera is used to determine a location of the user, and the direction from which the dual microphone array will capture sounds is represented by the audio cone 508A. In this manner, the direction from which the beam former should capture sound is determined by the direction in which the speaker's face/silhouette is detected. By providing the speaker's position periodically to the beam former algorithm it can dynamically adjust the beam direction. Accordingly, the user 510A can move as indicated by the arrow 512 to the position represented by the user 510B. The audio cone 508A is to shift position as indicated by the arrow 514A to the location represented by audio cone 508B. In the manner, the beam forming as described herein can be automatically adjusted to dynamically track the users position in real-time.

In embodiments, there may be more than one face in the camera's field of view. In such a scenario, audio cone may widen to include all faces. Each face may have a unique face ID and a different face rectangle, vertical position, horizontal position, and distance away from the camera. Additionally, when more than one face is detected within the camera's field of view, the user to be tracked by the beam forming algorithm may be selected via an application interface.

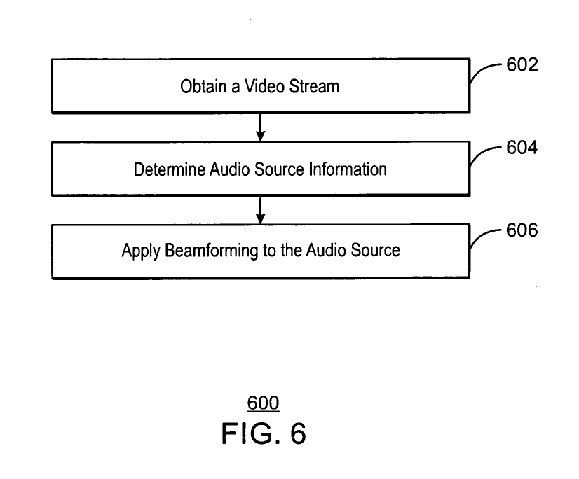

FIG. 6 is a process flow diagram of an example method for beam forming control via a video data stream. In various embodiments, the method 600 is used to attenuate noise in captured audio signals. In some embodiments, the method 600 may be executed on a computing device, such as the computing device 100.

At block 602, a video stream is obtained. The video stream may be obtained or gathered using an image capture mechanism. At block 604, the audio source information is determined. The audio source information is derived from the video stream. For example, a face detected in the field of view is described by the following information: face identification (ID), size identification, face rectangle, vertical position, horizontal position, and distance away from the camera.

At block 606, a beam forming direction is determined based on the audio source information. In embodiments, a user may choose a primary audio source to cause the beam forming algorithm to track a particular face within the camera's field of view.

The process flow diagram of FIG. 6 is not intended to indicate that the blocks of method 600 are to be executed in any particular order, or that all of the blocks are to be included in every case. Further, any number of additional blocks may be included within the method 600, depending on the details of the specific implementation.

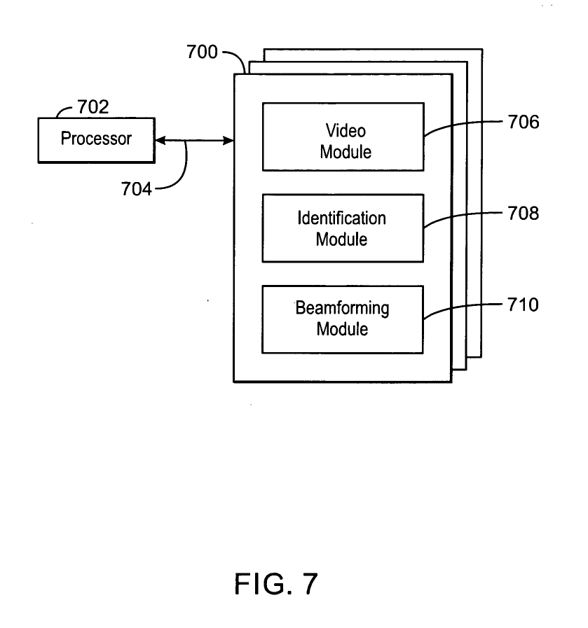

FIG. 7 is a block diagram showing a tangible, machine-readable media 700 that stores code for beam forming control via a video data stream. The tangible, machine-readable media 700 may be accessed by a processor 702 over a computer bus 704. Furthermore, the tangible, machine-readable medium 700 may include code configured to direct the processor 702 to perform the methods described herein. In some embodiments, the tangible, machine-readable medium 700 may be non-transitory.

The various software components discussed herein may be stored on one or more tangible, machine-readable media 700, as indicated in FIG. 7. For example, a video module 706 may be configured capture or gather video stream data. An identification module 708 may determine audio source information such as face identification (ID), size ID, face rectangle, vertical position, horizontal position, and distance away from the camera. A beam forming module 710 may be configured to determine a beam forming direction based on the audio source information. The block diagram of FIG. 7 is not intended to indicate that the tangible, machine-readable media 700 is to include all of the components shown in FIG. 7. Further, the tangible, machine-readable media 700 may include any number of additional components not shown in FIG. 7, depending on the details of the specific implementation.

Example 1 is a system for audio beamforming control. The system includes a camera; a plurality of microphones; a memory that is to store instructions and that is communicatively coupled to the camera and the plurality of microphones; and a processor communicatively coupled to the camera, the plurality of microphones, and the memory, wherein when the processor is to execute the instructions, the processor is to: capture a video stream from the camera; determine, from the video stream, an audio source position; capture audio from the primary audio source position at a first direction; and attenuate audio originating from other than the first direction.

Example 2 includes the system of example 1, including or excluding optional features. In this example, the processor is to analyze frames of the video stream to determine the audio source position.

Example 3 includes the system of any one of examples 1 to 2, including or excluding optional features. In this example, the first direction encompasses an audio cone comprising the audio source.

Example 4 includes the system of any one of examples 1 to 3, including or excluding optional features. In this example, the audio source is described by an identification number, an area rectangle, a vertical position, a horizontal position, a size identification, and an estimated distance from the camera.

Example 5 includes the system of any one of examples 1 to 4, including or excluding optional features. In this example, the audio source position is a periodic input to a beamforming algorithm.

Example 6 includes the system of any one of examples 1 to 5, including or excluding optional features. In this example, the audio source position is an event input to a beamforming algorithm.

Example 7 includes the system of any one of examples 1 to 6, including or excluding optional features. In this example, a beamforming algorithm is to attenuate audio originating from other than the first direction via destructive interference or other beamforming techniques.

Example 8 includes the system of any one of examples 1 to 7, including or excluding optional features. In this example, the audio is to be captured in the first direction via constructive interference or other beamforming techniques.

Example 9 includes the system of any one of examples 1 to 8, including or excluding optional features. In this example, the plurality of microphones is located equidistant from the camera. Optionally, the audio cone comprises a plurality of audio sources. Optionally, the plurality of audio sources are each assigned a unique identification number.

Example 10 is an apparatus. The apparatus includes an image capture mechanism; a plurality of microphones; logic, at least partially comprising hardware logic, to: locate an audio source in a video stream from the image capture mechanism at a location; generate a reception audio cone comprising the location; and capture audio from within the audio cone.

Example 11 includes the apparatus of example 10, including or excluding optional features. In this example, the video stream comprises a plurality of frames a subset of frames are analyzed to determine the audio source location.

Example 12 includes the apparatus of any one of examples 10 to 11, including or excluding optional features. In this example, the audio source is described by an identification number, an area rectangle, a vertical position, a horizontal position, a size identification, and an estimated distance from the camera.

Example 13 includes the apparatus of any one of examples 10 to 12, including or excluding optional features. In this example, the audio source location is a periodic input to a beamforming algorithm, and the beamforming algorithm results in audio capture within the audio cone.

Example 14 includes the apparatus of any one of examples 10 to 13, including or excluding optional features. In this example, the audio source location is an interrupt input to a beamforming algorithm, and the beamforming algorithm results in audio capture within the audio cone.

Example 15 includes the apparatus of any one of examples 10 to 14, including or excluding optional features. In this example, a beamforming algorithm is to attenuate audio originating from other than the audio cone via destructive interference or other beamforming techniques.

Example 16 includes the apparatus of any one of examples 10 to 15, including or excluding optional features. In this example, the audio is to be captured within the audio cone via constructive interference or other beamforming techniques.

Example 17 includes the apparatus of any one of examples 10 to 16, including or excluding optional features. In this example, the plurality of microphones is located equidistant from the image capture mechanism.

Example 18 includes the apparatus of any one of examples 10 to 17, including or excluding optional features. In this example, the audio cone comprises a plurality of audio sources. Optionally, the plurality of audio sources are each assigned a unique identification number, and each audio source is assigned an area rectangle, a vertical position, a horizontal position, a size identification, and an estimated distance from the camera. Optionally, audio source information is provided to a beamforming algorithm as a periodic input or an event.

Example 19 is a method. The method includes locating an audio source in a video stream from an image capture mechanism; applying a beamforming algorithm to audio from the audio source, such that the beamforming algorithm is directed towards an audio cone containing the audio source; and capturing audio from within the audio cone.

Example 20 includes the method of example 19, including or excluding optional features. In this example, the method includes adjusting the audio code based on a new location in the video stream.

Example 21 includes the method of any one of examples 19 to 20, including or excluding optional features. In this example, the video stream comprises a plurality of frames and a subset of frames are analyzed to determine the audio source location.

Example 22 includes the method of any one of examples 19 to 21, including or excluding optional features. In this example, the audio source is described by camera information comprising identification number, an area rectangle, a vertical position, a horizontal position, a size identification, and an estimated distance from the camera.

Example 23 includes the method of any one of examples 19 to 22, including or excluding optional features. In this example, camera information is applied to the beamforming algorithm.

Example 24 includes the method of any one of examples 19 to 23, including or excluding optional features. In this example, the beamforming algorithm is to attenuate audio originating from other than the audio cone via destructive interference.

Example 25 includes the method of any one of examples 19 to 24, including or excluding optional features. In this example, the audio is to be captured within the audio cone via constructive interference.

Example 26 includes the method of any one of examples 19 to 25, including or excluding optional features. In this example, the audio is captured via a plurality of microphones located equidistant from the image capture mechanism.

Example 27 includes the method of any one of examples 19 to 26, including or excluding optional features. In this example, the audio is captured via a plurality of microphones located any distance from the image capture mechanism.

Example 28 is a tangible, non-transitory, computer-readable medium. The computer-readable medium includes instructions that direct the processor to locate an audio source in a video stream from an image capture mechanism; apply a beamforming algorithm to audio from the audio source, such that the beamforming algorithm is directed towards an audio cone containing the audio source; and capture audio from within the audio cone.

Example 29 includes the computer-readable medium of example 28, including or excluding optional features. In this example, the computer-readable medium includes adjusting the audio code based on a new location in the video stream.

Example 30 includes the computer-readable medium of any one of examples 28 to 29, including or excluding optional features. In this example, the video stream comprises a plurality of frames and a subset of frames are analyzed to determine the audio source location.

Example 31 includes the computer-readable medium of any one of examples 28 to 30, including or excluding optional features. In this example, the audio source is described by camera information comprising identification number, an area rectangle, a vertical position, a horizontal position, a size identification, and an estimated distance from the camera.

Example 32 includes the computer-readable medium of any one of examples 28 to 31, including or excluding optional features. In this example, camera information is applied to the beamforming algorithm.

Example 33 includes the computer-readable medium of any one of examples 28 to 32, including or excluding optional features. In this example, the beamforming algorithm is to attenuate audio originating from other than the audio cone via destructive interference.

Example 34 includes the computer-readable medium of any one of examples 28 to 33, including or excluding optional features. In this example, the audio is to be captured within the audio cone via constructive interference.

Example 35 includes the computer-readable medium of any one of examples 28 to 34, including or excluding optional features. In this example, the audio is captured via a plurality of microphones located equidistant from the image capture mechanism.

Example 36 includes the computer-readable medium of any one of examples 28 to 35, including or excluding optional features. In this example, the audio is captured via a plurality of microphones located any distance from the image capture mechanism.

Example 37 is an apparatus. The apparatus includes instructions that direct the processor to an image capture mechanism; a plurality of microphones; a means to locate an audio source from imaging data; logic, at least partially comprising hardware logic, to: generate a reception audio cone comprising a location from the means to locate an audio source; and capture audio from within the audio cone.

Example 38 includes the apparatus of example 37, including or excluding optional features. In this example, the imaging data comprises a plurality of frames a subset of frames are analyzed to determine the audio source location.

Example 39 includes the apparatus of any one of examples 37 to 38, including or excluding optional features. In this example, the audio source is described by an identification number, an area rectangle, a vertical position, a horizontal position, a size identification, and an estimated distance from the camera.

Example 40 includes the apparatus of any one of examples 37 to 39, including or excluding optional features. In this example, the audio source location is a periodic input to a beamforming algorithm, and the beamforming algorithm results in audio capture within the audio cone.

Example 41 includes the apparatus of any one of examples 37 to 40, including or excluding optional features. In this example, the audio source location is an interrupt input to a beamforming algorithm, and the beamforming algorithm results in audio capture within the audio cone.

Example 42 includes the apparatus of any one of examples 37 to 41, including or excluding optional features. In this example, a beamforming algorithm is to attenuate audio originating from other than the audio cone via destructive interference or other beamforming techniques.

Example 43 includes the apparatus of any one of examples 37 to 42, including or excluding optional features. In this example, the audio is to be captured within the audio cone via constructive interference or other beamforming techniques.

Example 44 includes the apparatus of any one of examples 37 to 43, including or excluding optional features. In this example, the plurality of microphones is located equidistant from the image capture mechanism.

Example 45 includes the apparatus of any one of examples 37 to 44, including or excluding optional features. In this example, the audio cone comprises a plurality of audio sources. Optionally, the plurality of audio sources are each assigned a unique identification number, and each audio source is assigned an area rectangle, a vertical position, a horizontal position, a size identification, and an estimated distance from the camera. Optionally, audio source information is provided to a beamforming algorithm as a periodic input or an event.

In the foregoing description and following claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

It is to be understood that specifics in the aforementioned examples may be used anywhere in one or more embodiments. For instance, all optional features of the computing device described above may also be implemented with respect to either of the methods or the machine-readable medium described herein. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A system for audio beam forming control, comprising:
a camera;
a plurality of microphones;
a memory that is to store instructions and that is communicatively coupled to the camera and the plurality of microphones; and
a processor communicatively coupled to the camera, the plurality of microphones, and the memory, wherein when the processor is to execute the instructions, the processor is to:
capture a video stream from the camera;
determine, from the video stream, an audio source position;
capture audio from the primary audio source position at a first direction; and
attenuate audio originating from other than the first direction.

2. The system of claim 1, wherein the processor is to analyze frames of the video stream to determine the audio source position.

3. The system of claim 1, wherein the first direction encompasses an audio cone comprising the audio source.

4. The system of claim 1, wherein the audio source is described by an identification number, an area rectangle, a vertical position, a horizontal position, a size identification, and an estimated distance from the camera.

5. The system of claim 1, wherein the audio source position is a periodic input to a beam forming algorithm.

6. The system of claim 1, wherein the audio source position is an event input to a beam forming algorithm.

7. The system of claim 1, wherein a beam forming algorithm is to attenuate audio originating from other than the first direction via destructive interference or other beam forming techniques.

8. The system of claim 1, wherein the audio is to be captured in the first direction via constructive interference or other beam forming techniques.

9. The system of claim 1, wherein the plurality of microphones is located equidistant from the camera.

10. An apparatus, comprising:
an image capture mechanism;
a plurality of microphones;
logic, at least partially comprising hardware logic, to:
locate an audio source in a video stream from the image capture mechanism at a location;
generate a reception audio cone comprising the location; and
capture audio from within the audio cone.

11. The apparatus of claim 10, wherein the video stream comprises a plurality of frames a subset of frames are analyzed to determine the audio source location.

10. The apparatus of claim 10, wherein the audio source is described by an identification number, an area rectangle, a vertical position, a horizontal position, a size identification, and an estimated distance from the camera.

13. The apparatus of claim 10, wherein the audio source location is a periodic input to a beam forming algorithm, and the beam forming algorithm results in audio capture within the audio cone.

14. The apparatus of claim 10, wherein the audio source location is an interrupt input to a beam forming algorithm, and the beam forming algorithm results in audio capture within the audio cone.

15. The apparatus of claim 10, wherein a beam forming algorithm is to attenuate audio originating from other than the audio cone via destructive interference or other beam forming techniques.

16. The apparatus of claim 10, wherein the audio is to be captured within the audio cone via constructive interference or other beam forming techniques.

17. A method, comprising:
locating an audio source in a video stream from an image capture mechanism;
applying a beam forming algorithm to audio from the audio source, such that the beam forming algorithm is directed towards an audio cone containing the audio source; and
capturing audio from within the audio cone.

18. The method of claim 17, comprising adjusting the audio code based on a new location in the video stream.

19. The method of claim 17, wherein the video stream comprises a plurality of frames and a subset of frames are analyzed to determine the audio source location.

20. The method of claim 17, wherein the audio source is described by camera information comprising identification number, an area rectangle, a vertical position, a horizontal position, a size identification, and an estimated distance from the camera.

21. The method of claim 17, wherein camera information is applied to the beam forming algorithm.

22. A tangible, non-transitory, computer-readable medium comprising instructions that, when executed by a processor, direct the processor to:
locate an audio source in a video stream from an image capture mechanism;
apply a beam forming algorithm to audio from the audio source, such that the beam forming algorithm is directed towards an audio cone containing the audio source; and
capture audio from within the audio cone.

23. The computer-readable medium of claim 22, comprising adjusting the audio code based on a new location in the video stream.

24. The computer-readable medium of claim 22, wherein the video stream comprises a plurality of frames and a subset of frames are analyzed to determine the audio source location.

25. The computer-readable medium of claim 22, wherein the audio source is described by camera information comprising identification number, an area rectangle, a vertical position, a horizontal position, a size identification, and an estimated distance from the camera.
